(19) United States
(12) Patent Application Publication
(10) Pub. No.: US 2007/0251619 A1
(43) Pub. Date: Nov. 1, 2007

(54) Tire provided with a sensor placed between the carcass ply and the inner liner

(75) Inventor: David Bertrand, Besancon (FR)

Correspondence Address: COHEN PONTANI LIEBERMAN & PAVANE LLP;Thomas Langer, Suite 1210, 551 Fifth Avenue, New York, NY, 10176, US

(73) Assignee: Michelin Recherche et Technique S.A., Granges-Paccot (CH)

(21) Appl. No.: 11/731,495

(22) Filed: Mar. 30, 2007

Related U.S. Application Data
(60) Provisional application No. 60/800,921, filed on May 16, 2006.

(30) Foreign Application Priority Data
Mar. 30, 2006 (FR) 06/02805

(51) Int. Cl. B60C 19/08

(52) U.S. Cl. 152/152.1

(57) ABSTRACT

Tire comprising an inner liner, at least one carcass ply and a strain sensor, the strain sensor being placed between the carcass ply and the inner liner.

### RELATED APPLICATIONS

This application claims priority from U.S. Provisional Patent Application Ser. 60/800,921 filed May 16, 2006 and French application no. 06/02805 filed Mar. 30, 2006.

### BACKGROUND OF THE INVENTION

1. Field of the Invention

The present invention relates to tires provided with strain sensors and more particularly to the positioning of strain sensors in the structure of a tire.

2. Technical background

The assistance and monitoring systems present in vehicles are constantly being developed, with the objective of increasing comfort, performance and safety. Consequently, new needs are arising for the measurement of different parameters. Some of these parameters may be determined using sensors provided in the tires. In particular, variables associated with the stress to which the tires are exposed (tire deflection, tensor of forces at wheel centre, proximity of grip limit etc.) may be obtained by measuring deformation and strain in the tire.

In the field of measurements associated with the tire, it is possible to distinguish between two sub-fields: the measurement of variables associated with the internal air and the measurement of variables associated with the architecture and constituent materials of the tire.

The measurement of variables associated with the internal air, such as for example the pressure and temperature of the internal air, does not require the establishment of any special interface between the sensor and the tire. It is sufficient to provide a support designed for attaching the sensor (and optionally other electronic components) to the tire while protecting it from mechanical stresses by suitable decoupling.

It is quite a different matter when it comes to measuring variables associated with the architecture and constituent materials of the tire, such as for example tire deformation or strain arising at a given location. In this case, the quality of the mechanical interface between the sensor used and the surrounding environment is of the utmost importance. It is possible in particular to control the proportion of the deformation or strain transmitted to the sensor by careful selection of the geometric structure and of the materials of the support providing the interface.

It is known to provide a sensor in one of the parts constituting a tire. As an example, document US 2003/0056579 discloses a tire having a sensor of the “nail” type in a region that does not undergo wear. FIGS. 16 and 17 of this document suggest the implantation of the sensor in the lower part of the sidewall, close to the bead (FIG. 16) and in the region that connects the sidewall to the tread (FIG. 17). Document US 2004/0158441 teaches to provide a stress sensor close to the bead wire (see in particular, FIGS. 11 and 12).

### SUMMARY OF THE INVENTION

An object of the present invention is to optimize positioning of a strain sensor inside a tire.

This object is achieved by a tire comprising an inner liner, at least one carcass ply and a strain sensor, wherein the strain sensor is placed between the carcass ply and the inner liner.

“Inner liner” should here be understood to mean a mass of rubber mix (butyl-based for example) defined by an internal surface in contact with the gas inside the tire and an outer surface in contact with a carcass ply of the tire; this inner liner ensures the tightness of a tubeless tire.

Until now, to the best knowledge of the inventors, it has not been proposed to provide a sensor in the region between the carcass ply and the inner liner. There is indeed good reason for this. The person skilled in the art would avoid placing a sensor in the immediate vicinity of the inner liner because any damage done to this thin layer of rubber, for example during shaping of the tyre, would have a very considerable effect on the air tightness of the tyre.

Positioning of the sensor between the carcass ply and the inner liner has proven particularly advantageous, for the following reasons. Firstly, manufacture is easier and requires fewer operations than positioning of a patch, the effect being a shorter manufacturing time and lower cost. Secondly, this positioning provides good functional protection with regard to external attacks. Being positioned on the inside of the carcass ply, the sensor is protected by the outer sidewall and by the ply itself. Thirdly, the sensor is well protected with regard to attacks coming from the inside of the tire (humidity, oxidation, etc.), because it is placed behind the inner liner whose primary property is to provide a seal. Finally, the various architectures which may be used for the design of a tire have very little effect on said positioning. Thus, the solutions developed and validated for one given architecture may generally be reused for other architectures.

It may be noted that the skilled person wishing to protect a sensor against both external attacks (shocks, humidity, oxidation, . . . ) and attacks coming from the inside of the tyre (humidity, oxidation) would not naturally choose a position of the sensor between the carcass ply and the inner liner. He/she would rather choose a position in the bead because this is where the sensor is offered better protection as it is separated from the inside of the tyre by a greater quantity of rubber.

A tire according to the invention may in particular comprise a strain sensor comprising a rigid shank connected to a substantially flat and deformable diaphragm, the diaphragm comprising means for detecting deformation of the diaphragm, the shank being coupled mechanically to the carcass ply and/or to the inner liner of the tire. With regard to detection of the deformation of the diaphragm and the associated force measurement, reference may advantageously be made to the description in document U.S. Pat. No. 6,666,079.

Mechanical coupling of the shank to the carcass ply and/or to the inner liner of the tire may be effected by means of a quantity of material which fills the space between the carcass ply, the inner liner and the sensor. Preferably, a rubber material is used. The presence of such a material makes it possible to optimize the mechanical coupling between the sensor and the tire, in particular by careful selection of the rigidity of the material. A rubber material having a rigidity of between 2 and 15 MPa for 10% elongation has proven well suited to the majority of applications.

According to one particular embodiment, the material may exhibit a rigidity gradient. The rigidity of the material in the zones close to the inner liner and the carcass ply may advantageously be selected so as to be close to the rigidity of the rubber composition with which it is in contact (inner liner or carcass ply) or midway between the rigidity of the inner liner and of the carcass ply (typically between 2 to 6 MPa for 10% elongation). The rigidity of the material in the zones close to the sensor will then advantageously be greater than the rigidity of the inner liner and than the rigidity of the carcass ply and selected so as to approach the rigidity of the sensor.

According to one embodiment of the invention, the normal to the diaphragm of the sensor is parallel to the plane of the carcass ply, which makes it possible to measure shear strain in this plane. Advantageously, it is either oriented parallel to a radial direction, that is to say within a plane comprising the axis of rotation of the tire, or oriented perpendicularly to such a radial direction.

The sensor may in particular be placed in a bead zone or on a sidewall of the tire.

The sensor may also be placed under the crown of the tire; the sensor will then preferably be oriented in such a way as to orient the normal to the plane of the sensor diaphragm in the circumferential direction of the tire, which makes it possible in particular to gain access to the shear under the crown, in a plane parallel to the rolling surface of the tire, and to the compression in the direction of forward, movement of the tire. “Rolling surface” means the surface formed by the points of the tire's tread that come into contact with the ground when the tire is rolling.

Another embodiment of the invention consists in orienting the sensor diaphragm in such a way as to make it parallel to the carcass ply and to the inner liner, which makes it possible to determine a value representing the inflation pressure of the tire.

### BRIEF DESCRIPTION OF THE DRAWINGS

The invention will be better understood from the description of the drawings, in which:

FIG. 1 is a partial perspective view of a tire provided with a sensor;

FIG. 2 shows a three-dimensional strain sensor 20, of the “nail” type;

FIGS. 3 and 4 show embodiments of the invention;

FIG. 5 shows the positioning of the sensor relative to the carcass ply according to a first preferred embodiment;

FIG. 6 shows the positioning of the sensor on the tire according to this first preferred embodiment;

FIG. 7 shows a tire subject to two types of stress;

FIG. 8 shows a tire according to the invention before and after application of a load;

FIG. 9 shows the positioning of the sensor relative to the carcass ply according to a second preferred embodiment;

FIG. 10 shows the positioning of the sensor on the tire according to this second preferred embodiment;

FIG. 11 shows the positioning of the sensor according to a third preferred embodiment.

These Figures are schematic and given purely by way of example; they are in no way limiting.

### DETAILED DESCRIPTION OF THE INVENTION

FIG. 1 is a schematic representation of a conventional tire 10, comprising an inner liner 11 of impermeable rubber, a carcass ply 12 consisting of threads 13 coated in rubber mix (that is to say rubber composition comprising at least one elastomer and a filler), circumferential reinforcements 14 which hold the tire 10 on the rim (not shown) and a crown reinforcement comprising two plies 15, 16. Each of the plies 15 and 16 is reinforced by cords 17 and 18, which are inclined relative to a plane perpendicular to the axis of rotation of the tire. A tread 19 is placed on the plies 15 and 16; it is this tread 19 which ensures contact between the tire 10 and the road. The tire is fitted with a sensor 20 which is placed between the inner liner 11 and the carcass ply 12 and whose structure is illustrated in the following Figures. The sensor 20 is shown by dotted lines, because it is covered by the inner liner 11.

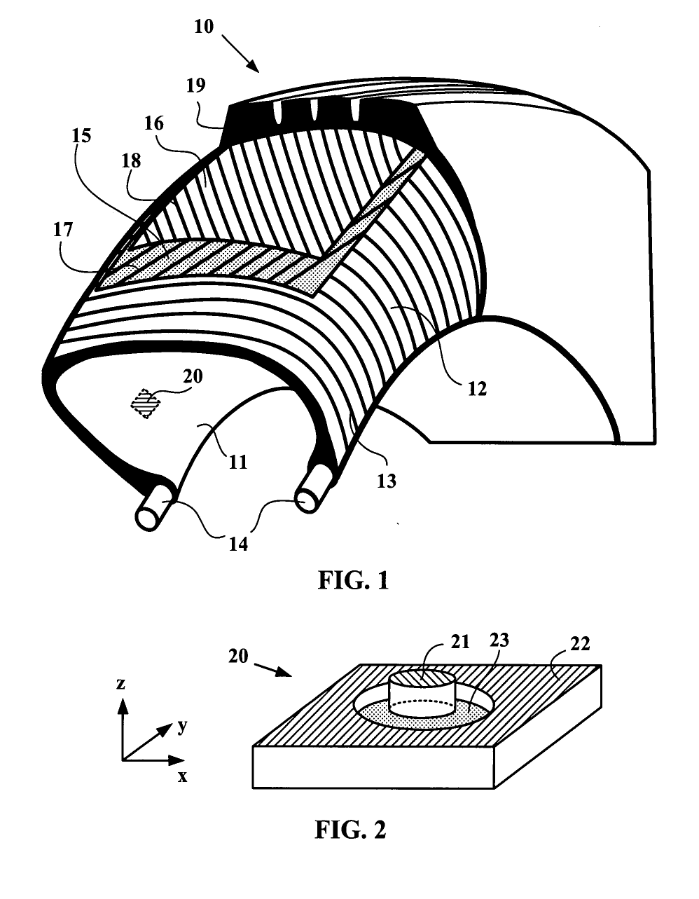

FIG. 2 is a schematic representation of a three-dimensional strain sensor 20, of the “nail” type. It is composed of a rigid shank 21 and a head 22 which comprises a deformable and substantially flat diaphragm 23 capable of deforming when the rigid shank 21, connected here to the centre of the diaphragm 23, is stressed by a force or a moment or alternatively when the entire structure of the measurement device is stressed by acceleration, the shank 21 then forming a seismic mass.

The diaphragm 23 is fitted with deformation gauges which allow it to issue signals proportional to the strain applied thereto:

strain normal to the diaphragm 23 (along z);

shear strain along x (σ_{xz});

shear strain along y (σ_{yz}).

The sensor thus described simultaneously measures these three strain components. (It should be noted that the Cartesian coordinate system (x, y, z) of FIG. 2 has been chosen only in order to illustrate the accessible stresses. Hereinafter, x, y, and z designate directions in a local reference system linked to the tire, x being the circumferential direction, y the axial direction and z the direction normal to both x and y.) With regard to detection of the deformation of the diaphragm 23 and the associated force measurement, reference may advantageously be made to the description in document U.S. Pat. No. 6,666,079.

Hereinafter, consideration will be given to such a sensor, but other strain sensors may be used in a tire according to the invention.

The sensor 20 designed for measuring local strain in the tire 10 and linking it to deformations of the tire 10 is integrated in the tire 10 at the time of manufacture thereof. Preferably, the sensor is placed as excess thickness between the carcass ply 12 and the inner liner 11.

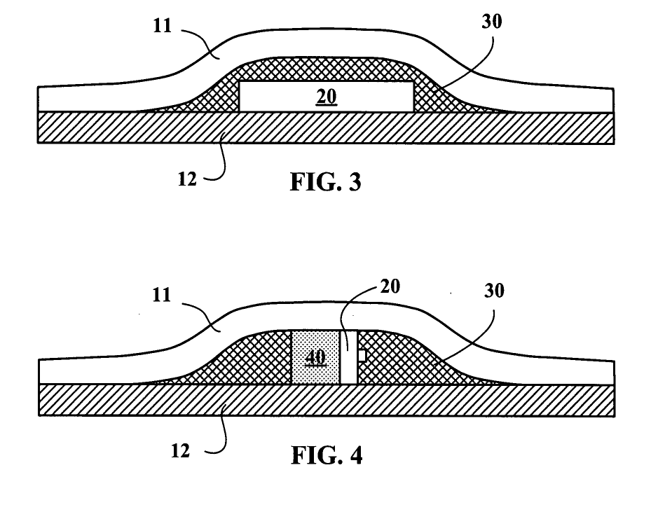

FIG. 3 shows one particular embodiment in which the sensor 20 is placed between the carcass ply 12 and the inner liner 11. It is very often desirable or necessary to fill the space between the carcass ply 12 and the inner liner 11 in the vicinity of the sensor 20 by adding a quantity of material 30, having suitable features, with the aim of optimizing mechanical coupling between the sensor 20 and the tire 10. In particular, the rigidity of the material and the shape of this quantity of material 30 are defined so as to:

prevent the build-up of strain at certain particular points (tapered shape),

prevent the formation of air bubbles during manufacture of the tire 10, and

control the level of strain transmitted to the sensor.

A very rigid material may transmit considerable strain, whereas a flexible material makes it possible to limit the level of strain on the diaphragm 23 of the sensor 20.

FIG. 4 is a schematic representation of an embodiment in which the sensor 20 (here associated with a processing module 40 attached thereto) is mounted in a position such that the normal to the diaphragm 23 thereof is parallel to the plane of the carcass ply 12. In this embodiment, the addition of the quantity of material 30 is necessary in order to obtain transmission to the sensor 20 of the strain on the tire 10. For the same deformation of the tire 10, the strain detected by the sensor 20 is substantially proportional to the rigidity of the material used to fill the space between the carcass ply 12 and the inner liner 11 in the vicinity of the sensor 20.

A sensor like the one described above makes it possible to measure different physical variables as a function of its position and its orientation. Different embodiments and possible uses thereof will be described in the following paragraphs.

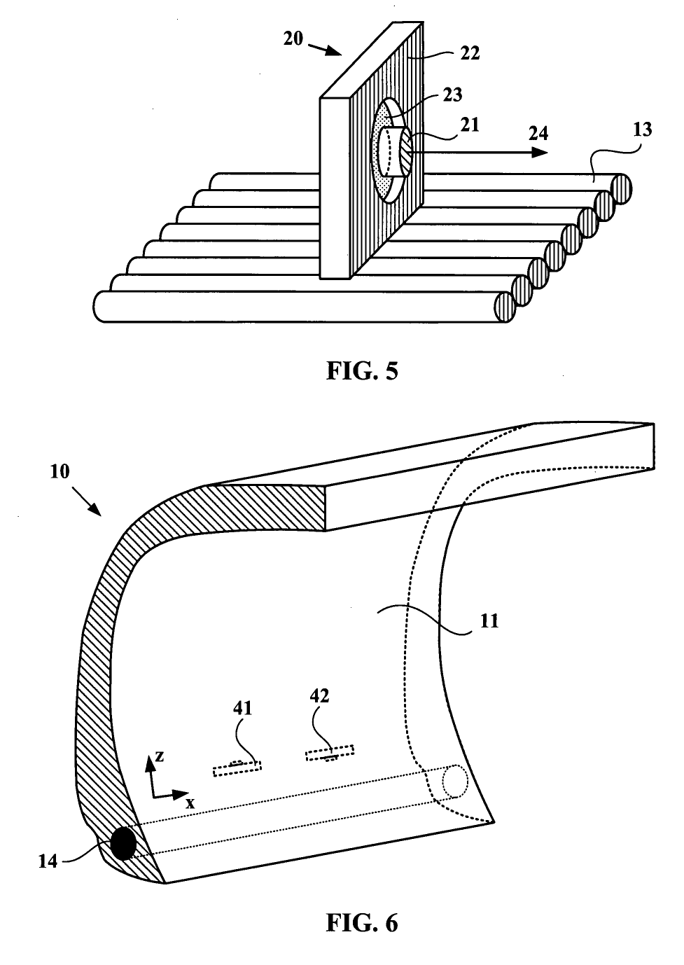

In a first preferred embodiment, the sensor 20 is placed in a bead zone or on a sidewall of the tire 10 and oriented such that the normal to the plane of the diaphragm 23 is oriented radially, that is to say parallel to a direction within a plane comprising the axis of rotation of the tire 10. FIG. 5 is a schematic representation of this situation for a tire 10 of radial structure. The normal to the plane of the diaphragm 23 (indicated by the arrow 24) is then parallel to the threads 13 of the carcass ply 12. The two positions which correspond to this orientation (and which give comparable results) are shown in FIG. 6: in the case of the sensor 42, the diaphragm faces the axis of rotation of the tire 10; in the case of the sensor 41, it faces in the opposite direction.

This preferred embodiment makes it possible in particular to measure the deradialisation and flexion of the sidewall of the tire 10.

Deradialisation of the tire 10 may be measured through the intermediary of the shear xz (σ_{xz}) of the diaphragm 23 of the sensor 20. When a tire 10 of radial type is subjected to stress as a result of loading or driving/braking torque, the tire deforms and the cables 13 of the carcass ply deviate from their radial orientation. This results in shear between the radial direction and the circumferential direction, and this shear may be detected by the sensor 20.

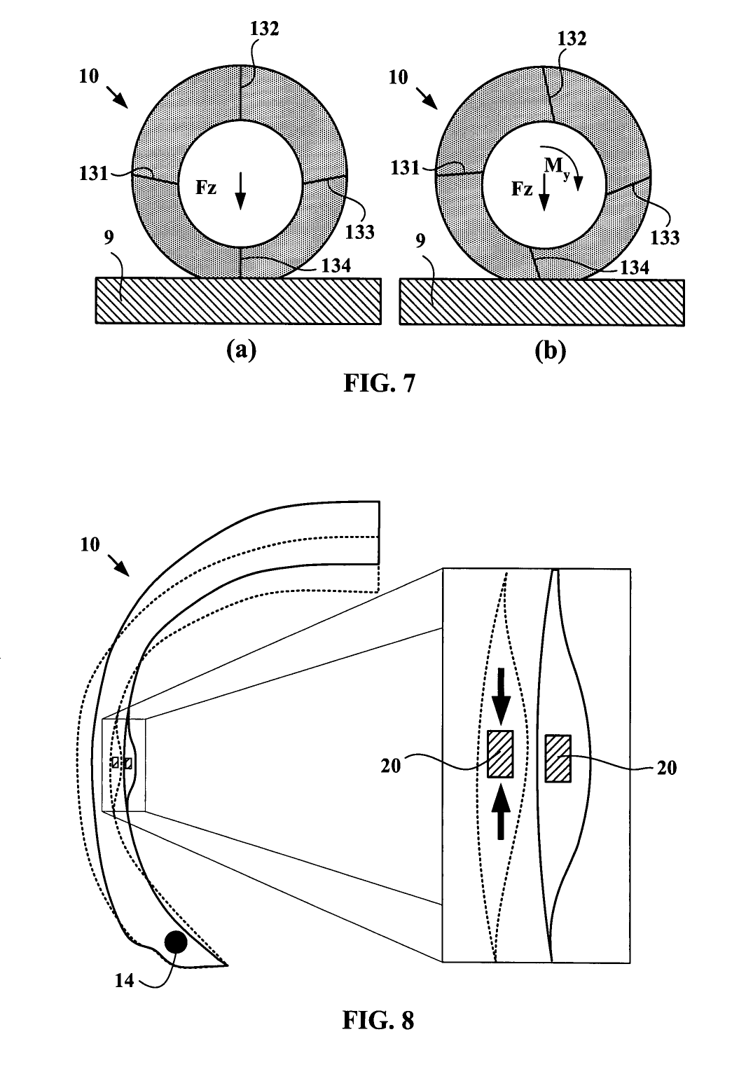

FIG. 7 is a schematic representation of a tire 10 in contact with the ground 9 and subject to two types of stress. FIG. 7(a) shows deradialisation of the tire 10 caused by the effect of a load Fz carried by said tire 10 when the tire is stationary. Of the four threads 131 to 134 which are illustrated, only the threads 131 and 133 undergo deradialisation when the force Fz is applied; the threads 132 and 134 retain their radial orientation. In FIG. 7(b), the tire 10 is additionally subjected to a driving torque M_{y}, which modifies the deradialisation: none of the threads 131 to 134 retain their radial orientation. It should be pointed out that the inclination of the threads relative to the radial position is not identical for all the threads: the deradialisation caused by the driving torque M_{y} may be added to the deradialisation caused by the force Fz (this is the case with the thread 133, for example) or have an opposing sign (as is the case with the thread 131).

The first preferred embodiment also makes it possible to measure the flexion of the sidewall through the intermediary of the strain normal to the diaphragm (z direction, see also FIG. 2). When the tire is loaded, the sidewall sags in the region corresponding to the contact area. FIG. 8 shows the difference between the two situations. The initial, non-loaded situation (solid lines) is compared to the loaded situation (dotted lines). In the loaded situation, the deformation of the sidewall results in increased strain (indicated by the arrows) on the sensor 20.

Awareness of the deradialisation and flexion of the sidewall of the tire 10 makes it possible to deduce the forces which cause the overall deformation of the tire. A number of applications may be envisaged; it thus becomes possible to determine the deflection of the tire (that is to say the variation in radial height of the tire, when the latter passes from an unloaded state to a loaded state) or its camber (that is to say the inclination of the axis of rotation of the tire relative to a plane parallel to the ground), or alternatively the tensor of the wheel centre forces, as explained in U.S. Pat. No. 6,962,075.

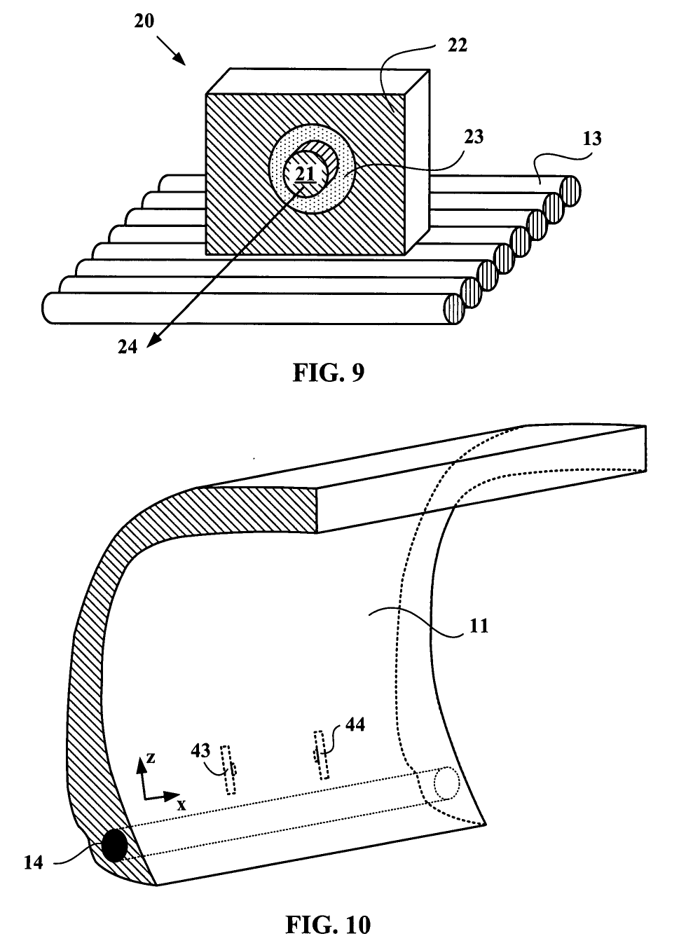

In a second preferred embodiment, shown schematically in FIG. 9, the sensor 20 is placed on the bead or on the sidewall of the tire and oriented such that the normal to the plane of the diaphragm (indicated by the arrow 24) is oriented perpendicularly to the radial direction (which corresponds to the direction of the threads 13 of the carcass ply) and parallel to the surface of the carcass ply. Once again, two positions, shown in FIG. 10, are possible and give comparable results: the diaphragm may face the direction of travel of the tire when the vehicle is moving forward (43) or in the opposite direction (44).

This particular embodiment principally allows measurement of the deradialisation of the tire 10 through the intermediary of the shear xz (σ_{xz}), in comparable manner to the first preferred embodiment, and the circumferential extension of the sidewall, through the intermediary of the strain normal to the diaphragm (x direction). These two variables provide information on the overall deformation of the tire and make it possible, as in the first preferred embodiment, to measure the deflection and/or the camber of the tire as well as the tensor of the wheel centre forces, as explained in patent application US 2004/158,414.

According to a third preferred embodiment, the sensor is placed under the crown of the tire, such that the normal to the diaphragm thereof is oriented in the circumferential direction, that is to say perpendicularly to the direction of the threads of the carcass ply and parallel to the ply. This embodiment makes it possible to gain access to two relevant variables: shear xy under the crown and compression in direction x.

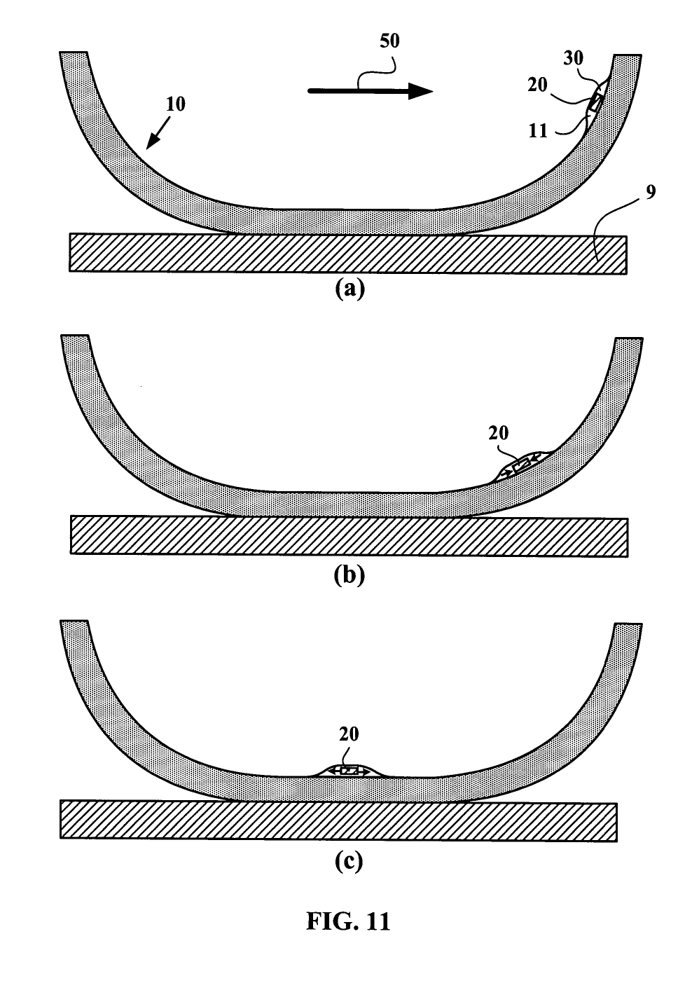

FIG. 11 shows this third embodiment in a radial section. It illustrates the development of the strain normal to the diaphragm of the sensor 20. The tire 10 moves forward in the direction indicated by the arrow 50. The Figure shows the tire at three successive instants. In FIG. 11(a), the sensor is located outside the contact zone between the tire 10 and the ground 9. The radius of curvature corresponds to the internal radius of the tire. In FIG. 11(b), the sensor is entering the contact zone; it is located in the connecting zone where the radius of curvature of the crown of the tire 10 is smaller. Consequently, the strain suffered by the diaphragm of the sensor 20 increases. Finally, in FIG. 11(c), the sensor is located in the contact zone between the tire 10 and the ground 9. The crown is flattened and the radius of curvature is infinite. The strain on the diaphragm of the sensor diminishes and may even change sign.

The applications associated with this embodiment may have the objective of estimating the deflection of the tire by providing an evaluation of the length of the contact area thanks to the compression signal in the circumferential direction.

According to a fourth preferred embodiment, the sensor is placed such that its diaphragm is parallel to the carcass ply and the inner liner. In this position, whether positioned in the bottom zone, in the sidewalls or under the crown, it makes it possible to determine from the normal strain a value representing the inflation pressure of the tire.

What is claimed is:

1- A tire comprising an inner liner, at least one carcass ply and a strain sensor, wherein the strain sensor is placed between the carcass ply and the inner liner.

2- The tire of claim 1, wherein the strain sensor comprises a rigid shank connected to a substantially flat and deformable diaphragm, the diaphragm comprising means of detecting deformation of the diaphragm, the shank being coupled mechanically to the carcass ply and/or to the inner liner of the tire.

3- The tire of claim 2, wherein mechanical coupling is effected by means of a quantity of material which fills the space between the carcass ply, the inner liner and the sensor.

4- The tire of claim 3, wherein the material which fills the space between the carcass ply, the inner liner and the sensor is a rubber material.

5- The tire of claim 3, wherein the material which fills the space between the carcass ply, the inner liner and the sensor has a rigidity of between 2 and 15 MPa for 10% elongation.

6- The tire of claim 3, wherein the material which fills the space between the carcass ply, the inner liner and the sensor exhibits a rigidity gradient, the zones close to the inner liner and to the carcass ply having a rigidity midway between the rigidity of the inner liner and the rigidity of the carcass ply and the rigidity of the material in the zones close to the sensor having a rigidity greater than the rigidity of the inner liner and of the rigidity of the carcass ply.

7- The tire of claim 2, wherein the normal to the diaphragm of the sensor is parallel to the plane of the carcass ply.

8- The tire of claim 7, wherein the normal to the plane of the diaphragm of the sensor is oriented parallel to a direction within a plane comprising the axis of rotation of the tire.

9- The tire of claim 8, wherein the sensor is placed in a bead zone or on a sidewall of the tire.

10- The tire of claim 7, wherein the normal to the plane of the diaphragm of the sensor is oriented perpendicularly to a direction within a plane comprising the axis of rotation of the tire.

11- The tire of claim 10, wherein the sensor is placed in a bead zone or on a sidewall of the tire.

12- The tire of claim 7, wherein the sensor is placed under the crown of the tire and wherein the normal to the plane of the diaphragm of the sensor is oriented in the circumferential direction of the tire.

13- The tire of claim 2, wherein the diaphragm of the sensor is parallel to the carcass ply and to the inner liner.
